(19) United States
(12) Patent Application Publication
(10) Pub. No.: US 2017/0247954 A1
(43) Pub. Date: Aug. 31, 2017

(54) An apparatus for electrical connection in wells and other remote environments

(71) Applicant: Artificial Lift Company Limited, Staines (GB)

(72) Inventors: Andras Bencze, Morden (GB); Matthew Benham, Houston, TX (US)

(73) Assignee: Artificial Lift Company Limited, Staines (GB)

(21) Appl. No.: 15/506,066

(22) PCT Filed: Jul. 3, 2014
(86) PCT No.: PCT/GB2014/052033

§ 371 Date: Feb. 23, 2017

(30) Foreign Application Priority Data
Aug. 23, 2013 (GB) 1315094.1

(51) Int. Cl. E21B 17/02; H01R 13/629; H01R 13/523

(52) U.S. Cl. CPC E21B 17/028; H01R 13/523; H01R 13/62905

(57) ABSTRACT

An apparatus comprising an electrically powered device. The apparatus comprises a functional device, a device electrical terminal, a casing, a power supply and a casing electrical terminal. The apparatus is characterised in that corresponding physical retaining means are provided on the device and the casing respectively, to ensure that physical connection between the device electrical terminal and the casing electrical terminal is maintained, during use of the apparatus. The physical retaining means of the apparatus automatically engages when the device is moved into the desired position relative to the casing.

### FIELD OF INVENTION

This invention relates to an apparatus for electrical connection in wells and other remote environments, for the deployment and retrieval of a powered device in a highly deviated or horizontal well.

### BACKGROUND OF THE INVENTION

Often electrical equipment is deployed downhole for the purpose of pumping, taking measurements or other down well applications requiring power. To provide the electrical power for these tools, one way is to run the electrical supply down the well along with the electrical device. Alternatively, an often more advantageous method is to run the cable down the casing of the well terminating in a connector and to use a plug attached to the powered device to connect to the connector, rather than deploying both equipment and electrical supply together. This deployable powered device must be reliably attachable, detachable and re-attachable for flexibility of use and maintenance of either the electrical device or plug head, or for installation, speed and convenience. It is important that the attachment can also easily align, orientate and secure the electrical junctions of the device reliably and at great depths, and distances.

In order to make an electrical connection downhole, the retrievable part of the wet connector (the plug head) must be able to locate and engage with sufficient security. The electrical connection must also be uninhibited by the fluid and material in the surrounding environment. At these great depths and distances from the well head it is important to locate and secure the connectors without allowing material from the well environment to degrade or interrupt the electrical connection. It is also advantageous for the connection to be reversible without reducing or damaging the fidelity of the connection.

GB2478108A, discloses a method of deploying and powering an electrically driven device in a well using guides in the casing of the well to align a plug arm which will engage with the permanently deployed wet connector and form an electrical connection. It is the object of the present invention to improve the performance of the electrical connection, especially in highly deviated or horizontal wells.

It is found that in some circumstances the connection can sometimes encounter problems with reliable electrical connectivity. This is especially the case in greatly deviated or horizontal wells.

It is an object of this present invention to reliably secure these types of electrical connections, specifically in the case of highly deviated or horizontal wells.

It is an object of the present invention to remotely connect and disconnect an electrical supply.

The invention is defined in the appended claims.

To deploy a reliable electrical connection at great depths, it is important to maintain connection with continuous force. Deviating boreholes often experience loss of the electrical connection. In the case of a vertical borehole this can be achieved through gravity alone, however greatly deviated and horizontal connections require a positive mechanical retention method.

In one aspect of the present invention a new leaf spring type latching cam is envisaged to latch into a corresponding part located in the well, providing a positive retention of the device when mated. It is also important to make the connection repeatedly attachable without damage, allowing for the device to be retrieved and redeployed. Disengagement of the latch is achieved through a sufficient pulling force (overpull), to overcome friction and the latching cam transversal spring force

Latching cam mechanism can also perform multiple mates and de-mates without affecting performance.

According to the present invention, an apparatus for electrical connection in wells and other remote environments, comprising: an electrically powered device comprising a functional device and a device electrical terminal; and a casing comprising a power supply, a casing electrical terminal, also known as wet connector, and casing shoulders, wherein corresponding physical retaining means are provided on the device electrical terminal and the casing electrical terminal respectively, to ensure that physical connection between the device terminal and the casing terminal is maintained. Preferably, the physical retaining means of the apparatus is engaged automatically, and automatic physical retaining means is engaged when the device is moved into the desired position relative to the device. The physical retaining means may include at least one latching cam located on the plug head. The latching cam may comprise an arm (leaf spring) and includes an enlarged portion at one end, which engages with a corresponding shoulder on the casing to prevent axial movement. Preferably, there are two latching cams, one on is each side of the electrical terminal of the device. Preferably, sufficient pulling force is required to release the latching cams from the corresponding shoulders and retrieve the device. Preferably, the latching cams of the electric device are guided along guides to the shoulders on the device terminal. The latching cams may perform multiple engagements and reengagements without effecting performance.

The present invention is particularly for use in wells of deviations greater than 67° to the horizontal.

### BRIEF DESCRIPTION OF DRAWINGS

FIG. 1: Shows the side view of the casing and device in the well.

FIG. 2: Shows the perspective view of the bottom hole assembly showing the fixed end and plughead mated.

FIG. 3: Shows the perspective view of the plughead with latch springs.

FIG. 4: Shows the perspective view of the latch spring.

FIG. 5: Shows the perspective view of the fixed end.

FIG. 6: Shows the perspective view of the plughead, latch spring, fixed end and pump can in unlatched configuration.

FIG. 7: Shows the perspective view of the plughead, latch spring, fixed end and pump can in latched configuration.

FIG. 8: Shows the top view of the plughead and fixed end de-mated and the latch spring disengaged from the pump-can.

FIG. 9: Shows the top view of the plughead and fixed end mated and the latch spring catching the pump-can.

### DETAILED DESCRIPTION

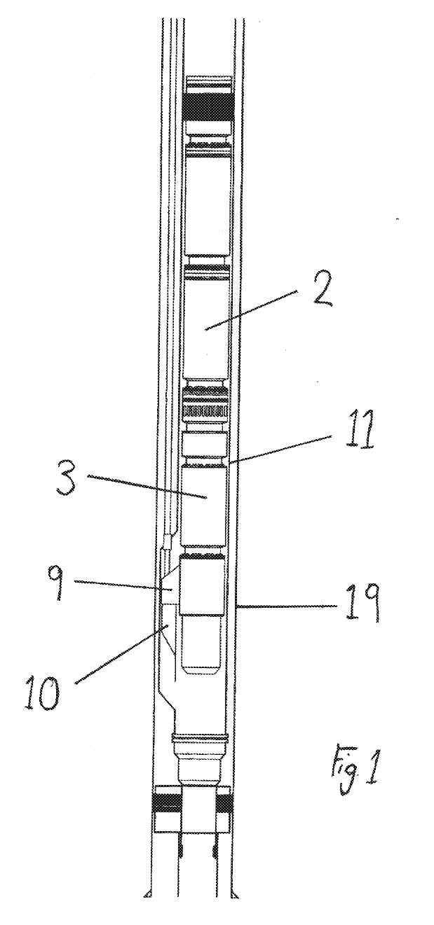

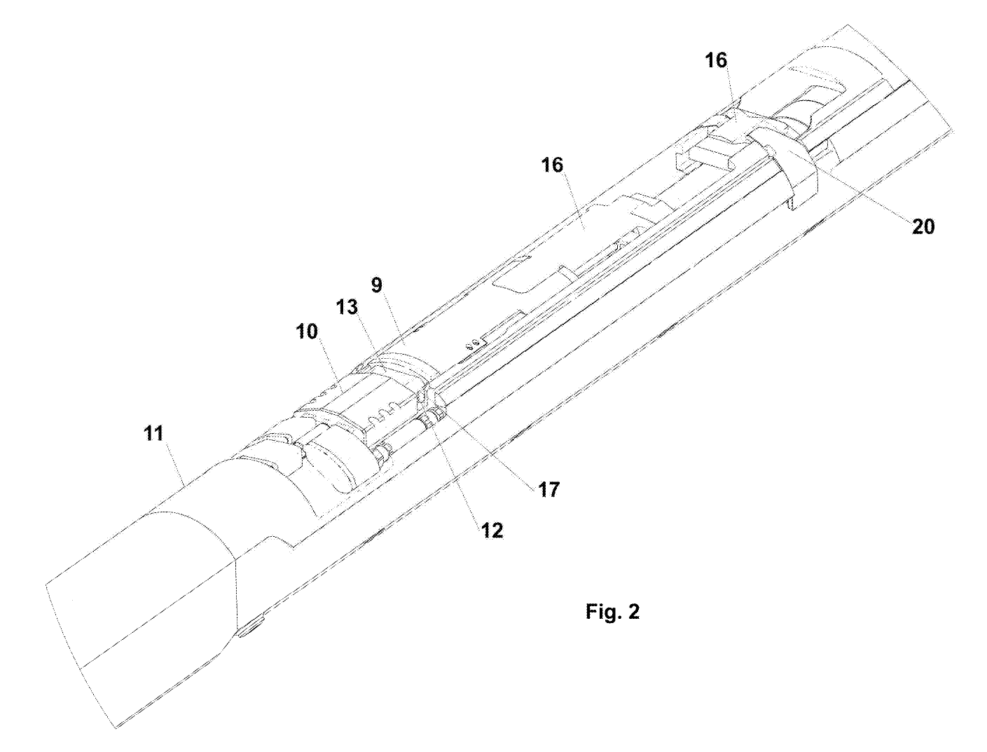

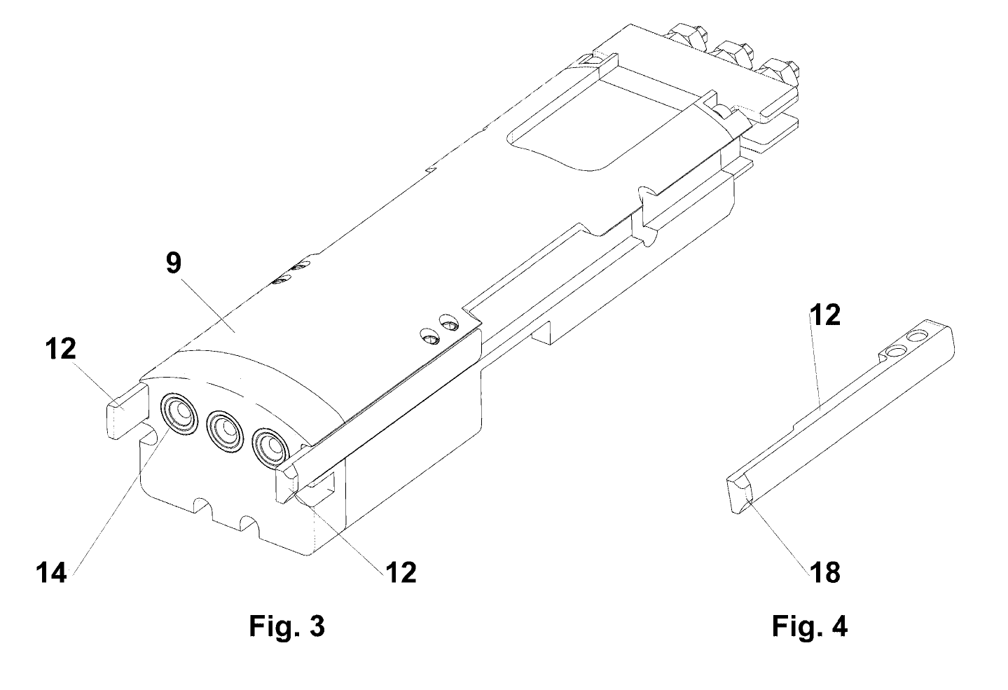

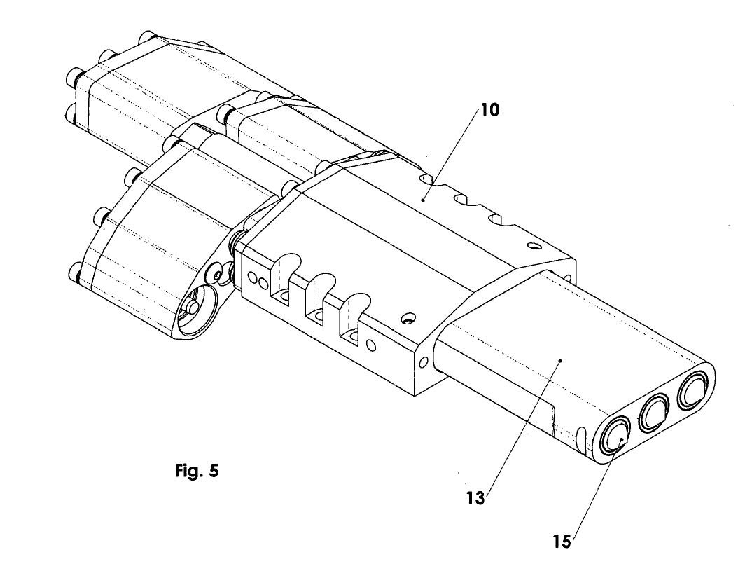

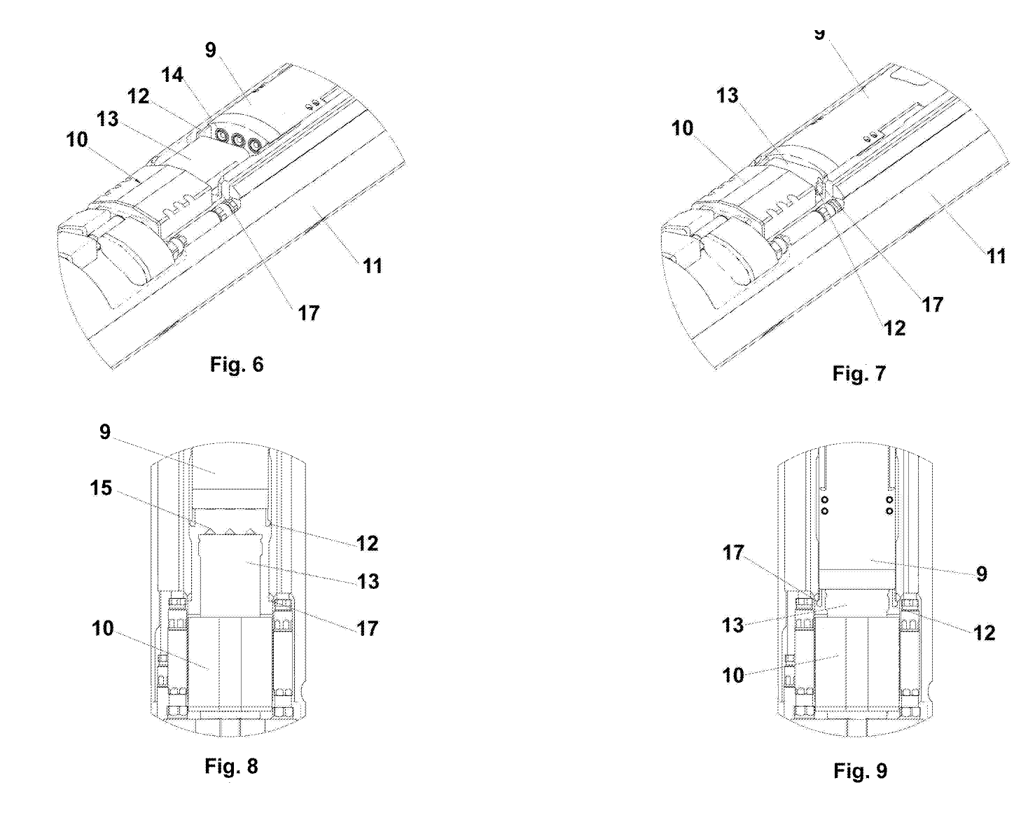

Referring to FIG. 1, a borehole 19 is shown in which is located a pump 2 driven by a pump motor 3, the motor has an electrical supply connector known as a plug head 9. The casing, also known as the pump can 11 with fixed end 10 will be already preinstalled into the well bore (FIG. 9), and also the casing electrical is terminal 15, also known as the wet connector, pre-located in the casing. A device electrical terminal 14 is located on the electrically powered device and engaged with the casing electrical terminal 15, to achieve electrical connection. The terminals are physically secured to each other by automatic springs, also referred to as latching cams 12 on either side of the device electrical terminal device. Electrical engagement is achieved by the insertion of male electrical connectors of the casing electrical terminals 15 into the corresponding female connectors of the device electrical terminals 14 to establish connection.

In the initial running position, the plug head 9, which houses the device electrical terminal 14, and the casing electrical terminal 15 are circumferentially aligned in the pump can 11. This is achieved by a helical slot or cam in the casing which is engaged by a corresponding follower or guide pin on the device, wherein the guide pin is moved along the slot as the device is lowered or pushed into position. By this means or similar the device achieves the desired orientation with response to the casing so that the respective electrical terminals are aligned circumferentially. Such orientation means per se are known in the art.

The plug arm 16, a constituent of the electrical device 3 which contains the device electrical terminal 14, is pushed by the attached coil tubing (not shown), from the well head (not shown) at the surface, using a coil tubing injector (not shown) until the plug head 9, on the end of the plug arm 16, extends fully into the lateral recess 21 on the pump can 11 and mates with the casing electrical terminals 15. During the mating of the terminals 14, 15, the latching cams 12 are guided, and deflected inwards, by the inner wall profile (not shown) of the pump can 11. This deflection of the latching cams 12 provides a frictional resistance force between the latching cams 12 and the inside wall (not shown), which is between 250N and 550N. This is the position shown in FIG. 8. FIG. 9 shows the position of the plug head 9 when it pushes together the male and female terminals 14, 15. The male terminals 15 are is covered by a sliding shroud 13, during the mating of terminal, the plug head 9 pushes the sliding shroud 13 against the compression springs (not shown) of the fixed end 10, allowing the male terminal 15 covered by the sliding shroud 13 into the female connectors 14, thereby the terminals are at all times covered by the shroud 13.

At completion of the connection the enlarged head of the latching cams 18 extend outwards, ready to lock onto the pump can shoulders 17. At this point the plug arm 16 is still subjected to an axial force via the coiled tubing (not shown) from the surface. After this load is removed, the plug arm 16 is displaced by the compression spring from the sliding shroud 13 and the coiled tubing latching cams 12 are urged against and hook onto the pump can shoulders 17 and are forced against the shoulders 17 by the compression spring of the sliding shroud 13. The terminals are now physically retained together ready for use.

After a period of use, the device can then be removed for either maintenance or repair. This is done by applying a pulling force by the coiled tubing from the surface. This pulling force exerted on the coiled tubing causes the cams 12 to deflect and un-latch. This pulling force must exceed the latching cam 12 transverse deflection force. The force required for this must be at least 3000N and may be as high as 7000N. Preferably, the force applied to release the device would be between 3000N and 5000N. This pulling force, or overpull, has to overcome not only the spring force of the latching cam 12 but, in addition, the frictional force of the device. The plug arm 16 is thereby detached and the device is at this point free to move and brought to surface by the retraction of the coiled tubing. Although coil tubing is required to deploy the device to provide sufficient axial force, the device may be released by the pulling force exerted by a wire line and retrieved to surface by means of the wire line, in particular if the device is deployed in a non-deviated well. The movement of the plug arm 16 during the pulling stage is restricted by drag from the latching cams 12, the plug arm 16 and the device 3 on the wall of the pump can 11. The casing includes a thrust brace 20 which retains the plug arm 16 upon release of the device. The plug head 9 or plug arm 16 cannot deviate laterally after the cams are unlatched because they are located in a lateral recess 21 in the casing wall or pump can 11.

In an alternative embodiment the latching cams 12 are disengaged by actuation in an inward direction, thus causing them to move out of engagement with the pump can shoulders 17 and permitting withdrawal of the device back to surface without the application a large pulling force or alternatively by a combination of a pulling force and actuation. The actuation could be performed by a pushing actuator located in the casing and controlled from surface and powered by the power supply.

### COMPONENT LIST

2—Pump
3—Pump motor
9—Plug Head
10—Fixed End
11—Pump Can
12—Latching Cam
13—Sliding shroud
14—Device Electrical Terminals
15—Casing Electrical Terminals
16—Plug Arm
17—Pump Can Shoulder
18—Enlarged head of the latching cams
19—Borehole
20—Thrust brace
21—Lateral recess

1. An apparatus for electrical connection in wells and other remote environments, comprising: an electrically powered device comprising a functional device and a device electrical terminal; and a casing comprising a power supply and a casing electrical terminal, characterized in that corresponding physical retaining means are provided on the device and the casing respectively, to ensure that physical connection between the device electrical terminal and the casing electrical terminal is maintained, during use of the device.

2. The apparatus according to claim 1, wherein the physical retaining means is engaged automatically.

3. The apparatus according to claim 1, wherein the automatic physical retaining means is engaged when the device is moved into the desired position relative to the casing.

4. The apparatus according to claim 1, wherein the physical retaining means includes at least one latching cam.

5. The apparatus according to claim 4, wherein the at least one latching cam is in the form of a spring arm.

6. The apparatus according to claim 4, wherein the at least one latching cam comprises a spring arm and includes an enlarged portion at one end which engages with a corresponding shoulder on the casing to prevent lateral movement.

7. The apparatus according to claim 4, wherein there are two latching cams, one on each side of the device electrical terminal.

8. The apparatus according to claim 1, wherein a sufficient overpull is applied to the device to release the physical retaining means and retrieve the device.

9. The apparatus according to claim 4, wherein the at least one latching cam of the electrical device is guided along guides in the casing.

10. The apparatus according to claim 5, wherein the at least one latching cam spring arm can perform multiple engagements and reengagements.

11. The apparatus according to claim 1, wherein the casing electrical terminal is covered by a sliding shroud.

12. The apparatus according to claim 11, wherein the sliding shroud exposes the electrical terminal upon engagement of the device electrical terminal.
